(19) United States
(12) Patent Application Publication
(10) Pub. No.: US 2026/0016144 A1
(43) Pub. Date: Jan. 15, 2026

(54) OPTIC FRAME

(71) Applicant: ABL IP Holding LLC, Atlanta, GA (US)

(72) Inventor: Vincent Adams, Snellville, GA (US)

(73) Assignee: ABL IP Holding LLC, Atlanta, GA (US)

(21) Appl. No.: 19/266,955

(22) Filed: Jul. 11, 2025

Related U.S. Application Data
(60) Provisional application No. 63/670,274, filed on Jul. 12, 2024.

(51) Int. Cl. F21V 19/00; F21V 5/00

(52) U.S. Cl. CPC F21V 19/0035; F21V 5/007; F21V 19/0015

(57) ABSTRACT

Embodiments are directed to an optic frame for discrete optics, light modules with such frames, and methods of assembling such light modules such that each discrete optics resides in a cell of the optic frame. The optic frame is designed to prevent or reduce the blockage of light from the light module and to isolate discrete optics from neighboring discrete optics such that the performance of one optic (e.g., thermal expansion) does not negatively impact the performance of neighboring optics.

### CROSS-REFERENCE TO RELATED APPLICATIONS

This application claims the benefit of and priority to U.S. Provisional Patent Application No. 63/670,274, filed on Jul. 12, 2024, which is hereby incorporated by reference in its entirety for all purposes.

### FIELD OF INVENTION

The present technology relates to light modules, and more particularly to optic frames for retaining discrete optics on light modules.

### DESCRIPTION OF THE RELATED ART

Light modules with arrayed optics are used in various indoor and outdoor settings. Some light modules include a printed circuit board (PCB) with light emitting diodes (LED) provided on the PCB in the desired number and array configuration and a lens that is positioned and attached over the PCB. Optics are formed in the lens such that each optic will align with an LED when the light module is assembled. Some materials used to form the lens (e.g., silicone) have a relatively high coefficient of thermal expansion such that they are apt to expand in size when exposed to the heat generated by the LEDs. Such expansion can result in misalignment between the LEDs and their respective optic on the lens.

### BRIEF SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the present disclosure are directed towards a frame used to retain discrete optics over LEDs within a light module.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top perspective view of one embodiment of a light module.

FIG. 2 is an exploded view of the light module of FIG. 1 with a few discrete optics removed to expose the underlying printed circuit board.

FIG. 3 is a side elevation view of the light module of FIG. 1.

FIG. 4 is a cross-sectional view of the light module of FIG. 1 taken along line 4-4.

FIG. 5 is a top perspective view of a discrete optic from the light module of FIG. 1 in isolation.

FIG. 6 is a top perspective view of the optic frame from the light module of FIG. 1 in isolation.

FIG. 7 is a bottom perspective view of the optic frame of FIG. 6.

FIG. 8 is a cross-sectional view of the optic frame of FIG. 6 taken along line 8-8.

FIG. 9 is a top perspective view of another embodiment of an optic frame in isolation.

FIG. 10 is a bottom perspective view of the optic frame of FIG. 9.

FIG. 11 is a top perspective view of another embodiment of a light module.

### DETAILED DESCRIPTION

Throughout this description for the purposes of explanation, numerous specific details are set forth in order to provide a thorough understanding of the many aspects and embodiments disclosed herein. It will be apparent, however, to one skilled in the art that the many aspects and embodiments may be practiced without some of these specific details. In other instances, known structures and devices are shown in diagram or schematic form to avoid obscuring the underlying principles of the described aspects and embodiments.

Described herein is a frame for retaining discrete optics within a light module, and light modules incorporating such frames and discrete optics.

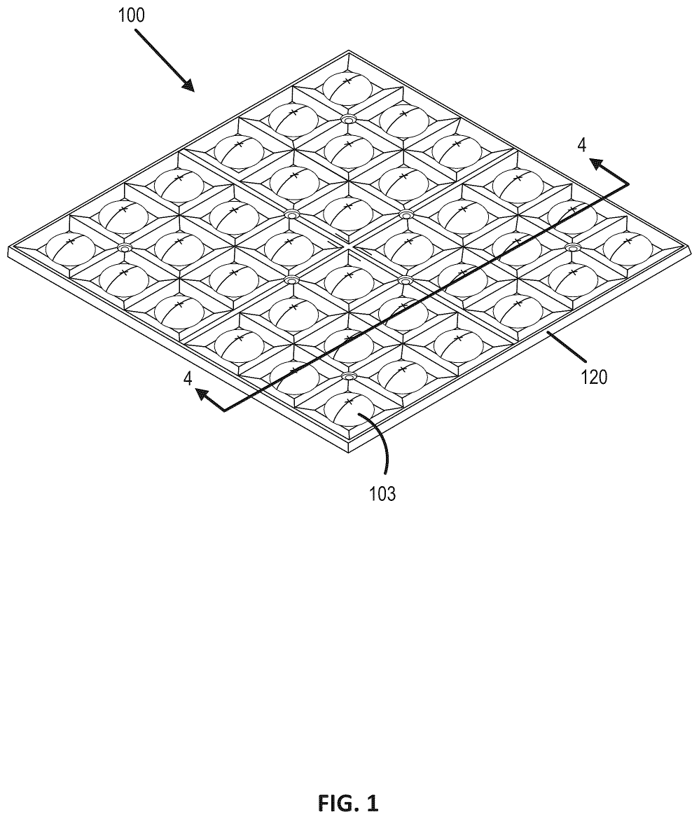

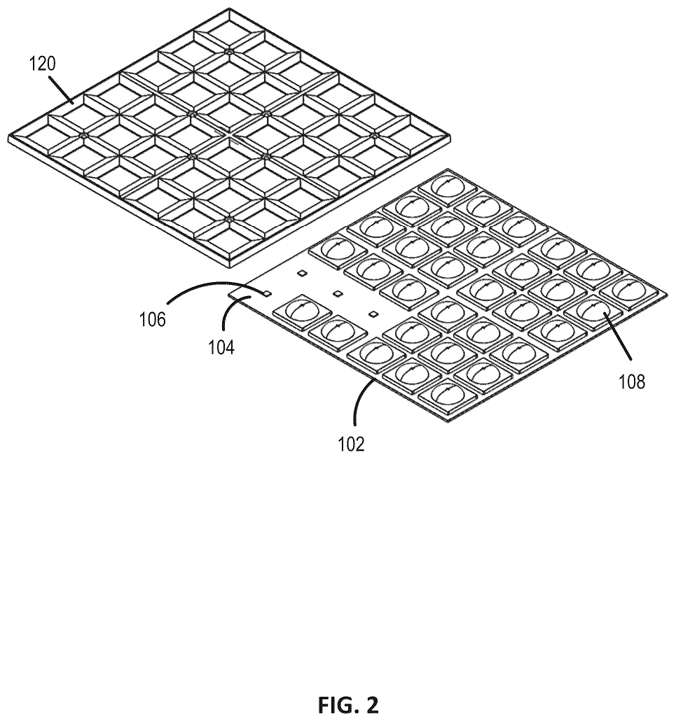

FIGS. 1-4 illustrate an embodiment of a light module 100 according to embodiments. The light module 100 generally includes a PCB 102 with an upper surface 104 on which are provided one or more light sources 106. Any number, type, or arrangement of light sources 106 may be provided on the upper surface 104 as desired. In the embodiment illustrated in FIGS. 1-4, the light module 100 includes LEDs as the light sources 106, and the LEDs are arranged in a 6×6 array on the upper surface 104.

Discrete optics 108 that are separate from the light sources 106 (i.e., not attached to the light sources 106) are positioned on the upper surface 104, and each discrete optic 108 is positioned over a corresponding light source 106.

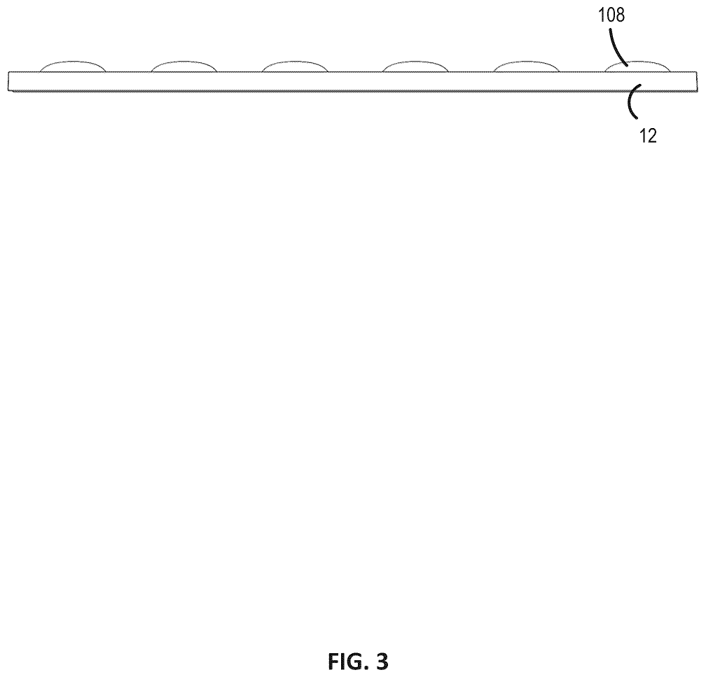

The discrete optic 108 (an embodiment of which is shown in isolation in FIG. 3) may be formed of any suitable material, including, but not limited to silicone, glass, and optical grade plastic materials such as optical grade acrylics (e.g., optical grade polymethylmethacrylate) and optical grade polycarbonate. In some embodiments, the optics 108 contemplated herein are formed of an optical grade silicone. However, as mentioned, in other embodiments, the optics 108 may be constructed from other materials as desired.

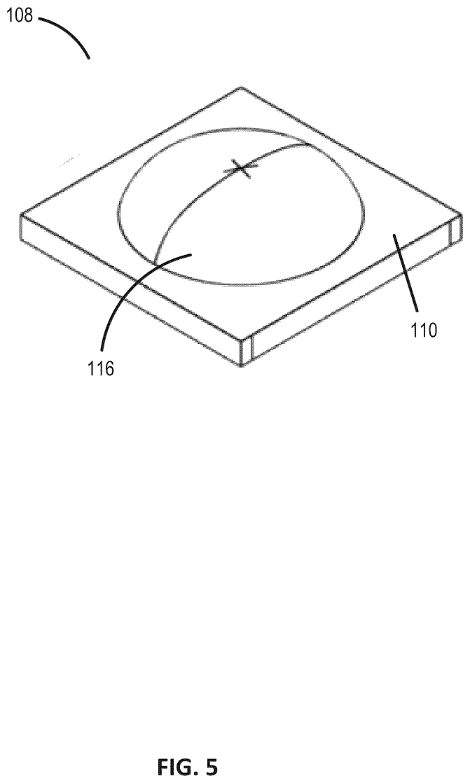

As illustrated in FIG. 5, the optic 108 includes a base 110 and an optical portion 116 that interacts with light emitted from its respective light source 106. The particular shape of the base 110 illustrated in FIG. 5 should not be considered limiting; rather, base 110 may have any suitable shape. The optical portion 116 may have any optical geometry (symmetrical or asymmetrical) to achieve the desired light distribution from the light module 100. Moreover, while the optical portions 116 of the optics on PCB 102 are illustrated as having the same optical geometry, the optical geometries of the optical portions 116 of the optics 108 provided within a light module 100 need not be the same. For optics 108 having optical portions 116 with asymmetrical geometries, the rotational orientation of such optics 108 need not be the same. Rather, the optics 108 may be provided at various rotational orientations on the PCB 102 as desired, and the rotational orientation of one optic 108 may be different from another optic 108 on the PCB 102.

The discrete optics 108 are assembled onto the PCB 102 by positioning each optic 108 in the desired rotational orientation over a corresponding light source 106 such that the light source 106 emits light into the optical portion 116 of the optic 108. The optical portion 116, in turn, may refract, reflect, and/or otherwise alter the directionality of at least some of the emitted light such that light is emitted from the optic 108 in a desired pattern or distribution.

The discrete optics 108 may be attached to the upper surface 104 of PCB 102 using various techniques as desired. In some embodiments, tape or adhesive may be interposed between the optic 108 (more specifically the optic base 110) and the PCB 102 to adhere one or more of the discrete optics 108 to the PCB 102.

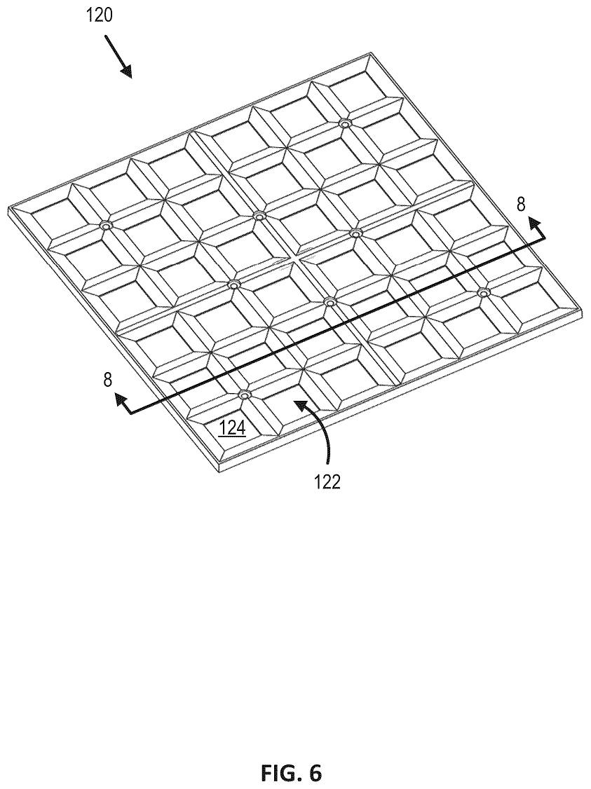

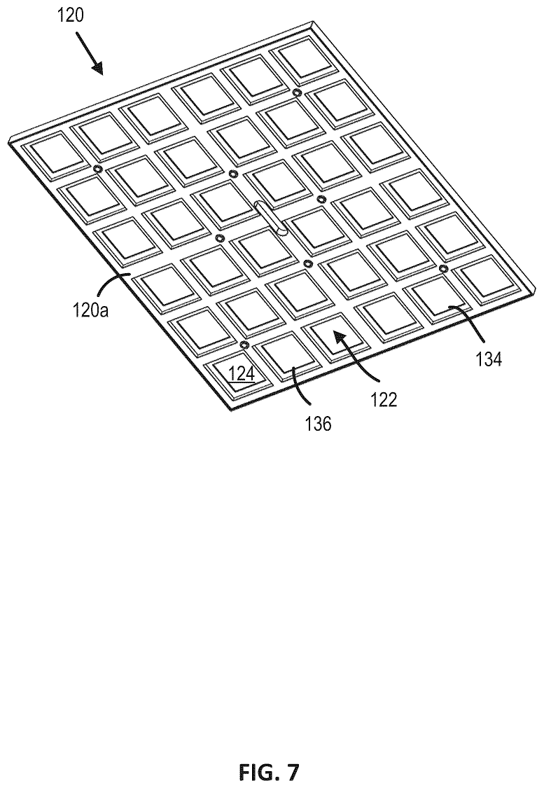

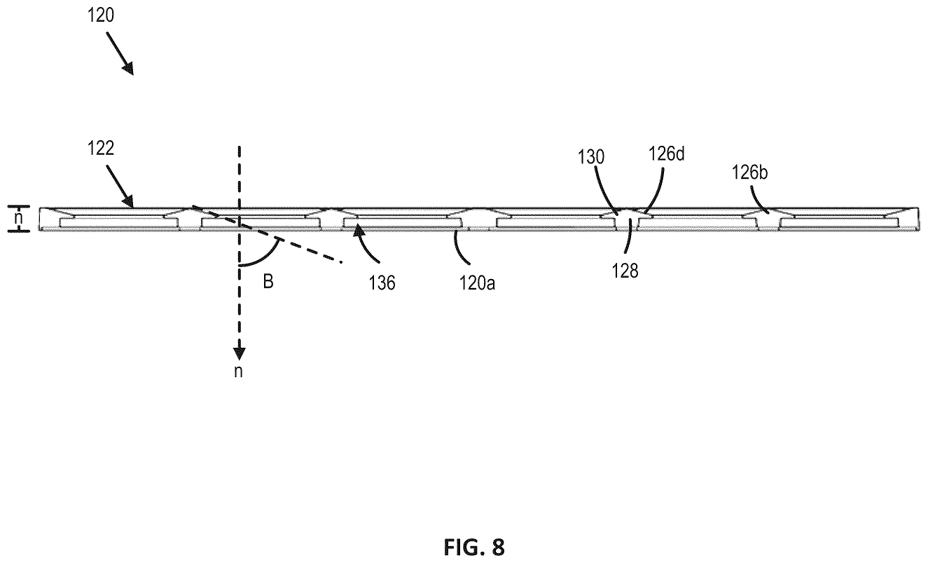

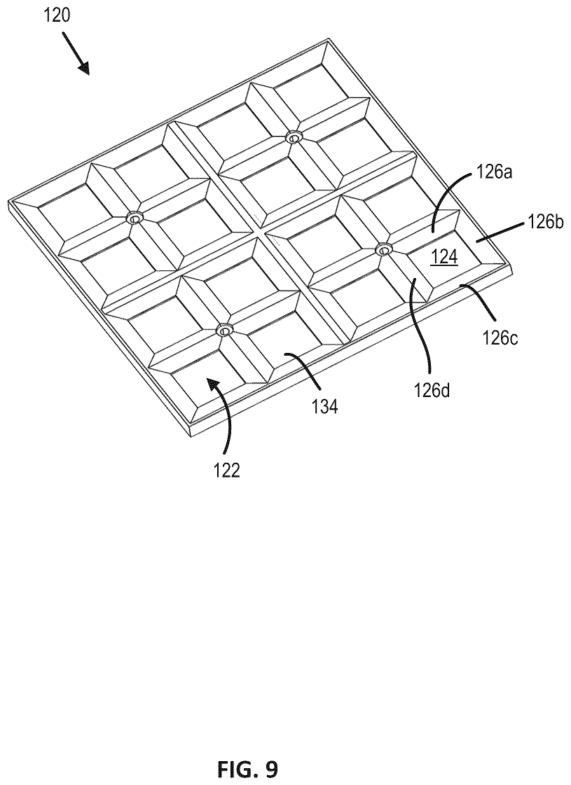

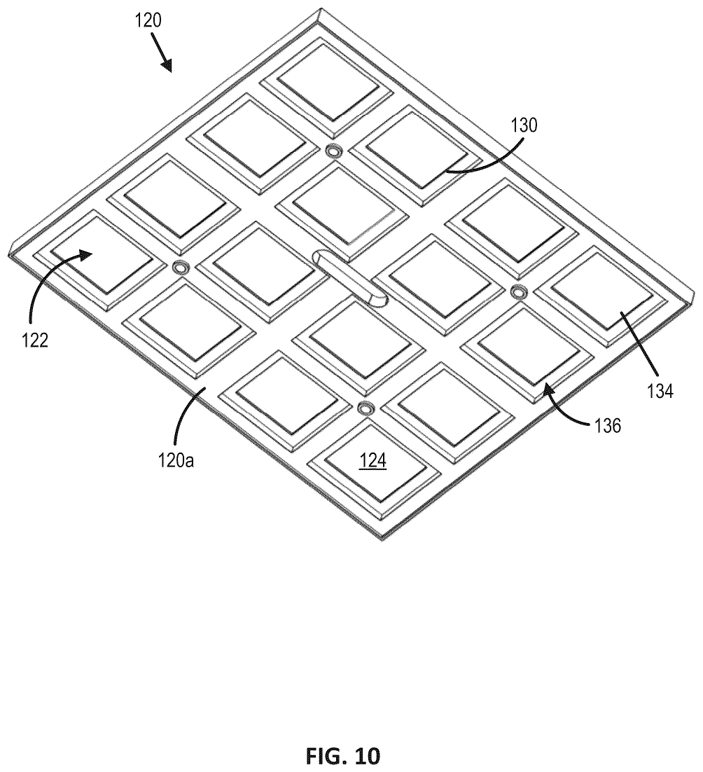

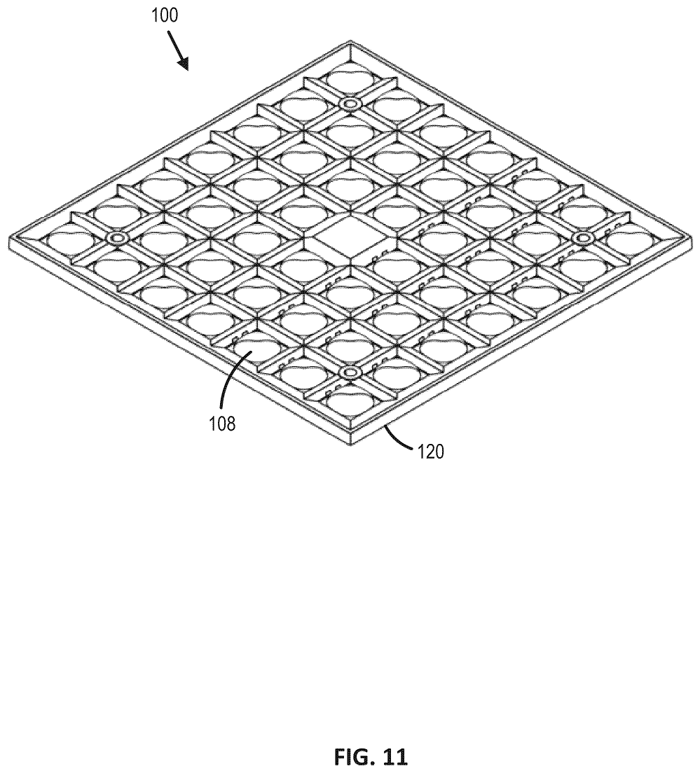

An optic frame 120 may then be positioned on the PCB 102. The optic frame 120 includes a plurality of frame cells 122, each having a cell aperture 124 designed to receive a discrete optic 108. Any number of frame cells 122 may be provided on the optic frame 120 and the number and arrangement of frame cells 122 within the optic frame 120 will typically depend on the number of discrete optics 108 on the PCB 102. The optic frame 120 may be easily scaled to accommodate different numbers and arrangements of discrete optics 108. For example, FIGS. 6-8 illustrate an optic frame 120 having a 6×6 array of frame cells 122, FIGS. 9 and 10 illustrate an optic frame having a 4×4 array of frame cells 122, and FIG. 11 illustrates a light module 100 with an optic frame having a 7×7 array of frame cells 122. While the illustrated optic frames 120 have a rectilinear shape, they may have any shape (square, rectangular, triangular, circular, oval, etc.).

In the illustrated embodiments, each frame cell 122 is defined by upstanding cell walls 126 (individually 126a-126d). In some embodiments, the cell walls 126 collectively define a grid-like pattern within the optic frame 120 such that the optic frame 120 includes rows and columns of frame cells 122. In some embodiments, the cell walls 126 extend continuously between the perimeter walls of the optic frame 120, but in other embodiments the cell walls 126 are discrete.

Each cell wall includes a base portion 128 and a flange portion 130 that extends outwardly from the base portion 128. The flange portion 130 includes an upper wall 132 that angles downwardly and inwardly towards the cell aperture 124 and terminates along edge 134. The edges 134 of the cell wall 126a-126d collectively define the cell aperture 124. In this way, the crosswise dimension of the frame cell 122 is greater than the crosswise dimension of the cell aperture 124.

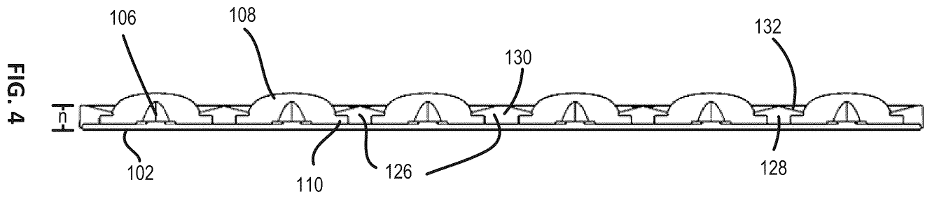

The base portions 128 and the flange portions 130 of each cell wall 126a-126d collectively create an undercut 136 in the lower surface 120a of the optic frame 120 at each frame cell 122. The undercut 136 is sized and shaped to receive the base 110 of an optic 108, as can be seen in FIG. 4. In this way, the base 110 of each optic 108 is trapped beneath the flange portions 130 of a frame cell 122 to help retain the optic 108.

In the illustrated embodiment, the shape of the frame cell 122 is substantially the same as the shape of the cell aperture 124 (i.e., both are square), but such is not a requirement. Rather, the shape of the frame cell 122 may be different than the shape of the cell aperture 124 that it defines. Moreover, the frame cells 122 and/or cell apertures 124 may have different shapes within a single optic frame 120.

The cell aperture 124 may be shaped and sized such that the edge(s) 134 defining the cell aperture 124 is immediately adjacent the optical portion 116 of the discrete optic 108 such that only the optical portion 116 is visible when the optic frame 120 is positioned on the PCB 102. However, in other embodiments a portion of the base 110 of the optic 108 is also visible within the cell aperture 124.

The cell walls 126a-126d preferably are designed such that they block little to no light emitted by the LEDs to maximize the lumen output from the light module 100. The cell walls 126a-126d may be of any vertical height n which in some embodiments will depend upon the height of the LEDs, the spacing between the LEDs, and the desired cutoff angle. The cell walls 126 within the optic frame 120 can, but need not, all have the same vertical height n. Rather the vertical height n of the cell walls 126 may vary within the optic frame 120. In some embodiments, the optical portion 116 of the optic 108 extends beyond the vertical height n of the cell walls 126a-126d (see FIG. 4). Moreover, the angle B between the angled upper wall 132 of the flange portion 130 of each cell wall 126a-126d and nadir n should be high enough to prevent light being lost to the optic frame 120. In some embodiments, angle B (the cutoff angle) will be greater than 40°, 50°, 60°, and/or 70° but less than 90° relative to nadir, such as between 50°-85°, inclusive; 55°-80°, inclusive; 60°-80°, inclusive; 65°-80°, inclusive; 65°-75°, inclusive; 70°-85°, inclusive; 70°-80°, inclusive; and/or 75°-80°, inclusive, relative to nadir.

The optic frame 120 is positioned on the PCB 102 such that each frame cell 122 receives a corresponding discrete optic 108. Screws or other fastening features (not shown) are used to attach the optic frame 120 to the PCB 102 and compress the optic frame 120 (as well as the discrete optics 108) against the PCB 102. In this way, a seal is created between the discrete optics 108 and the PCB 102. In the illustrated embodiment, screws holes 140 are provided in the optic frame 120 to receive screws for attaching the optic frame 120 to the PCB 102.

The optic frame 120 may be formed integrally of any material (e.g., silicone, polymeric, metallic, etc.) but in some embodiments is formed of a material having a low coefficient of thermal expansion so as to retain its shape when subjected to heat. In some embodiments, the optic frame 120 is formed of an acrylic or other type of polymer (e.g., acrylonitrile butadiene styrene), or blends thereof or alternatively from a metallic material, including a non-ferrous material such as aluminum. In some embodiments, the optic frame 120 is opaque or semi-opaque, but in other embodiments the optic frame 120 may be transparent or clear. Further, in some embodiments the optic frame 120 may be rendered reflective, such as for example by rendering the cell walls 126a-126d reflective.

In some embodiments, the discrete optics 108 and the optic frame 120 may be formed of different materials selected to capitalize on the benefits of the different materials while mitigating the drawbacks of those materials. For example, the discrete optics 108 may be formed of silicone, which has high thermal stability (i.e., does not degrade under heat), while the optic frame 120 may be formed of cheaper polymeric materials that are less thermally stable. The optic frame 120 thus imparts rigidity to retain the discrete optics 108 in place and combat their thermal expansion and is distanced from the heat generated by the light sources 106. Rather, the more thermally resistant silicone material forming the discrete optics 108 is located more proximate the light sources 106 and serves to insulate the optic frame 120 from heat generated by the light sources 106. The optic frame 120 further isolates the discrete optics 108 from each other to buffer an optic 108 against any thermal expansion that a neighboring optic 108 may undergo.

Use of discrete optics 108 also allows for improved customization of the light module 100 as desired. As an example, discrete optics 108 having different distributions may be provided on a single PCB 102, and identical discrete optics 108 need not be used on the PCB 102. As a further example, the orientation of each discrete optic 108 on the PCB 102 may be independently controlled, and the rotational orientation of the discrete optics 108 need not be the same. This design flexibility enables customization and control of the light distribution from the light module 100.

A method of assembling the light module 100 may include providing the PCB 102 with the plurality of light sources 106. In various embodiments, the method includes providing LEDs as the plurality of light sources 106. The method includes selecting discrete optics 108 to achieve the desired distribution and attaching each discrete optic 108 to the PCB 102 such that the optic 108 covers a corresponding light source 106. In some embodiments, the method may include controlling an orientation of the discrete optic 108 relative to the PCB 102. In certain embodiments, attaching the discrete optics 108 to the PCB 102 may include using an adhesive or tape to attach the optics 108 to the PCB 102. The method may include securing an optic frame 120 onto the PCB 102. The optic frame 120 may include a plurality of frame cells 122, each frame cell having a cell aperture 124. Securing an optic frame 120 onto the PCB 102 may include positioning the optic frame 120 relative to the PCB 102 such that each cell aperture 124 receives at least a portion of a discrete optic 108. The method may further include assembling the light module 100 into a light fixture (not shown).

As discussed above, use of discrete optics that are untethered to the other optics on the PCB injects multiple degrees of freedom into the light module design. For example, identical optics need not be used on the PCB. Rather, optics having different distributions can be provided on a single PCB. Moreover, the rotational orientation of the optics need not be aligned; rather, each optic enjoys rotational freedom and can be rotationally oriented independent from the other optics on the PCB. In this way, the overall light distribution of the light fixture can be tailored for particular applications. Embodiments of the methods contemplated herein enable creation of customized light modules and steps of the method may be controlled to effectuate creation of such light modules.

The various aspects, embodiments, implementations or features of the described embodiments can be used separately or in any combination. In particular, it should be appreciated that the various elements of concepts from the figures may be combined without departing from the spirit or scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A light module comprising:
a printed circuit board comprising an array of a plurality of light sources provided on an upper surface of the printed circuit board;
a plurality of discrete optics, each discrete optic positioned over one of the plurality of light sources in a rotational orientation; and
a frame secured to the printed circuit board and comprising a plurality of frame cells each having a cell aperture, wherein each cell aperture receives one of the plurality of discrete optics.

2. The light module of claim 1, wherein each discrete optic comprises silicone.

3. The light module of claim 2, wherein the frame comprises a polymeric or metallic material.

4. The light module of claim 1, wherein each discrete optic comprises a base and an optical portion having an optical geometry.

5. The light module of claim 4, wherein only the optical portion of each discrete optic is visible within the cell aperture.

6. The light module of claim 4, wherein a portion of the base of each discrete optic is visible within the cell aperture.

7. The light module of claim 4, wherein the optical geometry of at least some discrete optics is identical.

8. The light module of claim 4, wherein the optical geometry of at least some discrete optics is different.

9. The light module of claim 4, wherein the optical geometry of at least some discrete optics is asymmetrical.

10. The light module of claim 9, wherein the rotational orientation of at least one of the discrete optics differs from the rotational orientation of at least one other of the discrete optics.

11. The light module of claim 1, wherein the frame comprises perimeter walls and a plurality of cell walls that extend between opposing perimeter walls to define the plurality of frame cells.

12. The light module of claim 11, wherein the plurality of cell walls defines a plurality of rows and a plurality of columns of frame cells.

13. The light module of claim 11, wherein the cell walls comprise a vertical height and wherein an optical portion of each discrete lens extends beyond the vertical height of the cell walls.

14. The light module of claim 1, wherein the frame comprises a plurality of cell walls that define the plurality of frame cells and wherein the plurality of cell walls are interposed between the plurality of discrete optics such that each discrete optic is separated from all adjacent discrete optics by at least one of the plurality of cell walls.

15. The light module of claim 1, wherein each frame cell is defined by at least one upstanding cell wall comprising a base portion and a flange portion that extends outwardly from the base portion, wherein the flange portion of the at least one upstanding cell wall is adapted to extend over a portion of a discrete optic.

16. The light module of claim 15, wherein the discrete optic comprises a base and an optical portion and wherein the flange portion is adapted to extend over the base of the discrete optic.

17. The light module of claim 15, wherein the flange portion comprises an upper wall that angles downwardly towards the frame cell at an angle relative to nadir.

18. The light module of claim 17, wherein the angle is greater than 40° and less than 90°.

19. The light module of claim 15, wherein the at least one upstanding cell wall comprises four upstanding cell walls.

20. A light module comprising:
a printed circuit board comprising an array of a plurality of light sources provided on an upper surface of the printed circuit board;
a plurality of discrete optics, each discrete optic comprising silicone and having a base and an optical portion, wherein each discrete optic is positioned over one of the plurality of light sources; and
a frame secured to the printed circuit board, the frame formed of a polymeric or metallic material and comprising perimeter walls and a plurality of cell walls that extend between opposing perimeter walls to define a plurality of frame cells each having a cell aperture, wherein each cell aperture receives one of the plurality of discrete optics and wherein the plurality of cell walls are interposed between the plurality of discrete optics such that each discrete optic is separated from all adjacent discrete optics by at least one of the plurality of cell walls.
